(19) United States
(12) Patent Application Publication
(10) Pub. No.: US 2014/0028555 A1
(43) Pub. Date: Jan. 30, 2014

(54) METHOD AND APPARATUS FOR CONTROLLING DRAG FOR A MOVING OBJECT OF A MOBILE TERMINAL HAVING A TOUCH SCREEN

(71) Applicant: Samsung Electronics Co., Ltd., Gyeonggi-do (KR)

(72) Inventors: Seungah OH, Seoul (KR); Yeji PARK, Seoul (KR); Ilgeun BOK, Seoul (KR); Eunju TAE, Seoul (KR)

(73) Assignee: Samsung Electronics Co., Ltd., Gyeonggi-do (KR)

(21) Appl. No.: 13/952,838

(22) Filed: Jul. 29, 2013

(30) Foreign Application Priority Data
Jul. 30, 2012 (KR) 10-2012-0082895

(51) Int. Cl. G06F 3/0354

(52) U.S. Cl. CPC G06F 3/03547
USPC 345/158

(57) ABSTRACT

A method and apparatus for controlling a drag to variably change the speed of an object moving on a display unit includes displaying an object and a control region for controlling a movement of the object, wherein if a touch input is detected from the control region, the control unit determines whether duration of a drag input after the initial touch input is longer than a predetermined time period, then the control unit defines a ratio of a drag speed and an object speed, based on the determination outcome so that the object is moved in response to the drag input according to the defined ratio.

### CLAIM OF PRIORITY

This application claims the benefit under 35 U.S.C. §119(a) to a Korean patent application filed on Jul. 30, 2012 in the Korean Intellectual Property Office and assigned Ser. No. 10-2012-0082895, the entire invention of which is hereby incorporated by reference.

### BACKGROUND

1. Field of the Invention

The present invention relates generally to a method and apparatus for controlling drag for moving an object of a mobile terminal having a touch screen.

2. Description of the Related Art

Recently mobile terminals have developed into multimedia devices that provide various types of additional services such as, for example, an electronic note function, a game function, a schedule management function, and the like. This requires a user interface that allows a user to easily use and manage such services.

Normally when an object such as a cursor or an image is moved by means of a drag action, a drag speed and an object speed are set equally. In this case, actual movement of a drag corresponds to a speed of an object in a ratio of 1 to 1. However, when there is a need to move a cursor in a sentence having a small font size and a narrow spacing, it is difficult to move a cursor minutely.

Accordingly, there is a need to address the above-mentioned problems and/or disadvantages and to offer at least the advantages described below.

### SUMMARY

An aspect of the present invention is to provide a drag control method and apparatus in which when a drag input is detected after a predetermined time has elapsed from the time point of a touch input, the ratio of a drag speed to an object speed is defined variably.

In accordance with one exemplary aspect of the present invention, a method for controlling a drag for moving an object in a mobile terminal having a touch screen includes: displaying a control region for controlling a movement of the object; if an initial touch input is detected from the control region, checking duration of when a drag input is completed; based on the duration of the drag input completion, defining a ratio of a drag speed to an object speed; and moving the object in response to the drag input according to the defined ratio.

In accordance with another exemplary aspect of the present invention, a mobile terminal includes: a touch screen configured to display an object and a control region for controlling a movement of the object, and to receive a user's input for moving the object; and a control unit configured to, if a touch input is detected from the control region, check duration when a drag input is completed, to define a ratio of a drag speed and an object speed, based on the detection time of the drag input, and to move the object in response to the drag input according to the defined ratio.

According to this invention, when a drag input is detected after a predetermined time has elapsed from the initial time point of a touch input, the ratio of a drag speed to an object speed is defined according to predetermined criteria which in turn moves a cursor minutely in a sentence having a small font size and a narrow spacing or to scroll image items or list items quickly.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a block diagram illustrating a mobile terminal in accordance with an exemplary embodiment of the invention;

FIG. 2 is a flow diagram illustrating a method for controlling a drag for moving an object in accordance with an exemplary embodiment of the invention;

FIG. 3 is a schematic diagram illustrating a process of moving an object if a drag speeds and an object speed are set equally;

FIG. 4 is a schematic diagram illustrating a process of moving an object if a drag speed and an object moving speed are set differently;

FIGS. 5A and 5B are schematic diagrams illustrating a process of moving a cursor if a drag speeds and a cursor speed are set equally;

FIGS. 6A, 6B and 6C are schematic diagrams illustrating a process of moving a cursor if a drag speeds and a cursor speed are set differently;

FIG. 7 is a schematic diagram illustrating a process of moving image items if a drag speed and an image movement speed are set equally;

FIG. 8 is a schematic diagram illustrating a process of moving image items if a drag speed and an image movement speed are set differently;

FIG. 9 is a schematic diagram illustrating a process of moving a list of items if a drag speed and a list speed are set equally; and

FIG. 10 is a schematic diagram illustrating a process of moving list items if a drag speeds and a list speed are set differently.

Throughout the drawings, the same or like drawing reference numerals will be understood to refer to the same or like elements, features and structures.

### DETAILED DESCRIPTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this invention will be thorough and complete, and will fully convey the scope to those skilled in the art.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

At the outset, some terms used herein will be defined.

The term object refers to the target being touched, dragged, and moved. In some embodiments of the present invention, the object may include, but not limited to, a cursor, an image item, a list item, and the like.

The term control region refers to an area where a touch and/or a drag input occur to control the movement of an object. The object may be displayed at the inside or outside of the control region.

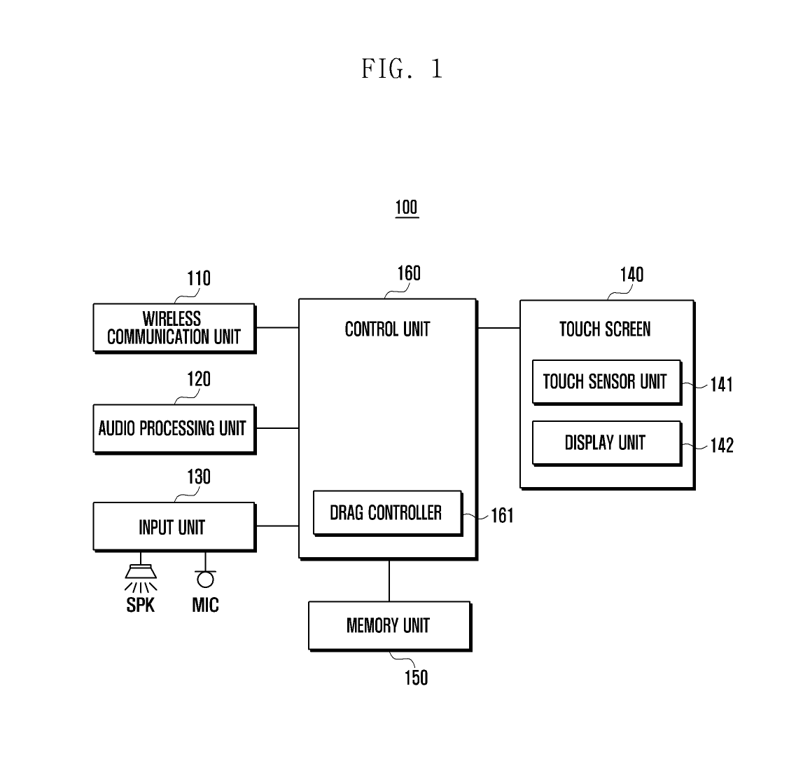

FIG. 1 is a block diagram illustrating a mobile terminal in accordance with an exemplary embodiment of the invention.

As shown in FIG. 1, the mobile terminal 100 may include a wireless communication unit 110, an audio processing unit 120, an input unit 130, a touch screen 140, a memory unit 150, and a control unit 160.

The wireless communication unit 110 performs a function to transmit and receive data for wireless communication of the mobile terminal 100. The wireless communication unit 110 may include an RF transmitter (not shown) that up-converts the frequency of an outgoing signal and then amplifies the outgoing signal, and an RF receiver (not shown) that low-noise amplifies an incoming signal and down-converts the frequency of the incoming signal. The wireless communication unit 110 may also output data received through a radio channel to the control unit 160, and transmit data outputted from the control unit 160 through a radio channel.

The audio processing unit 120 may be composed of CODECs which have a data CODEC for processing packet data, etc., and an audio CODEC for processing audio signals such as voice. The audio processing unit 120 converts digital audio signals into analog audio signals through the audio CODEC and then outputs them through the speaker (SPK). Also, the audio processing unit 120 converts analog audio signals inputted from the microphone (MIC) into digital audio signals by the audio CODEC.

The input unit 130 receives user's key manipulations for controlling the mobile terminal 100, creates input signals, and transfers them to the control unit 160. The input unit 130 may be formed of a keypad having alphanumeric keys and navigation keys, and may further have function keys provided on lateral sides of the mobile terminal 100. In some embodiments, any mobile terminal which can only be manipulated using the touch screen 140 may not have the input unit 130. The input unit 130 may receive, from a user, a touch input and/or a drag input for moving an object.

The touch screen 140 includes a touch sensor unit 141 and a display unit 142. The touch sensor unit 141 detects user's touch input. The touch sensor unit 141 may be composed of touch sensors of capacitive overlay type, resistive overlay type, or infrared beam type, or pressure sensors. Alternatively, in another embodiment, any other sensors capable of detecting a touch or a pressure may be used for the touch sensor unit 141. After detecting a user's touch input, the touch sensor unit 141 creates a touch detection signal and sends it to the control unit 160. The touch detection signal contains coordinate data of user's touch input. If the user moves a touch point, the touch sensor unit 141 creates touch detection signals including coordinate data of a moving path of a touch point, and sends them to the control unit 160.

The display unit 142 may be formed of LCD (Liquid Crystal Display), OLED (Organic Light Emitting Diodes), AMOLED (Active Matrix Organic Light Emitting Diodes), or any other equivalent. The display unit 142 visually offers, to a user, a menu of the mobile terminal 100, inputted data, function setting information, and any other information. The display unit 142 performs a function to output a booting screen, an idle screen, a menu screen, a call screen, and any other application executing screen of the mobile terminal 100.

The memory unit 150 stores programs and data required for operation of the mobile terminal 100 and may include a program region (not shown) and a data region (not shown). The program region may store a program for controlling the whole operations of the mobile terminal 100, an operating system (OS) for booting the mobile terminal 100, an application required for playing multimedia contents, and an application required for performing optional functions of the mobile terminal 100, such as a camera, an audio play, an image view, or a video play. The data region may store data created while the mobile terminal 100 is used, such as images, videos, phonebook, audio data, and the like.

In one embodiment, the memory unit 150 stores at least one particular program for defining the ratio of a drag speed to an object speed as a certain unequal value and for moving an object on the basis of the defined ratio when a drag input is detected after a predetermined time has elapsed from the time point of a touch input.

The control unit 160 controls the whole operations of the mobile terminal 100. Particularly, when a drag input is detected after a predetermined time has elapsed from the time point of a touch input, the control unit 160 may control a series of processes of defining the ratio of a drag speed to an object speed as a certain unequal value and, based on the defined ratio, of moving an object in response to a drag input. To this end, the control unit 160 may further include a drag controller 161.

If a touch input is detected in a control region (not shown), the drag controller 161 checks the time when a drag input is initially detected. Then, based on duration of the drag input completion, the drag controller 161 defines the ratio of a drag speed to an object speed. Thereafter, based on the defined ratio, the drag controller 161 controls the movement of the object in response to the drag input.

Specifically, if a drag input is detected after a predetermined time (i.e., 0.5 second) has elapsed from the initial time point of a touch input, the drag controller 161 defines the ratio of a drag speed to an object speed as a certain unequal value. In contrast, if a drag input is detected and completed before the predetermined time has elapsed from the initial time point of a touch input, the drag controller 161 defines the ratio of a drag speed to an object speed as an equal value.

Although the control unit 160 and the drag controller 161 are described above as separate blocks for performing different functions, it is merely for ease of description. Alternatively, in another embodiment, the control unit 160 may absorb specific functions of the drag controller 161.

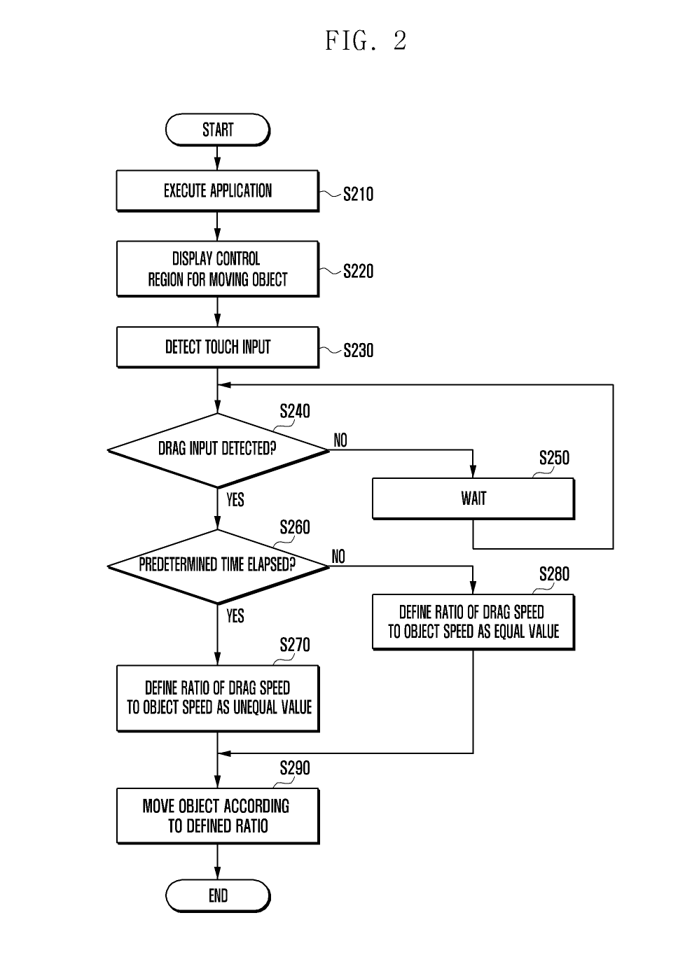

FIG. 2 is a flow diagram illustrating a method for controlling a drag for moving an object in accordance with an exemplary embodiment of the invention.

First, the control unit 160 detects any executed applications at step S210. The applications may include, but not limited to, a gallery, a video, a phonebook, an Internet connection, and the like. In embodiments, an application may be selected having an object to be moved depending on a user's drag input.

When the application is executed, the control unit 160 displays the control region for moving an object at step S220. As described above, the object may be a cursor, an image item, a list item, and the like. Also, the object may be displayed at the inside or outside of the control region.

At step S230, the control unit 160 detects that a touch input is received. Then, at step S240, the control unit 160 determines whether a drag input is detected. If a drag input is not detected, the control unit 160 waits for a drag input at step S250.

If a drag input is detected, the control unit 160 determines at step S260 whether a predetermined time has elapsed from the time point of a touch input. Namely, the control unit 160 determines whether a drag input is detected after an elapse of a predetermined time from a detection of a touch input. The predetermined time is a variable value and may be 0.5 second, 1 second, or the like.

If the predetermined time has not elapsed, the control unit 160 sets equally a drag speed and an object speed at step S280. Namely, the ratio of a drag speed to an object speed is defined as an equal value. This means that the distance of a moving object is set to be equal to the distance of a drag input.

In contrast, if the predetermined time has elapsed, the control unit 160 sets differently a drag speed and an object speed at step S270. Namely, the ratio of a drag speed to an object speed is defined as an unequal value. Specifically, an object speed may be set to be smaller than a drag speed or set to be greater than a drag speed. This ratio is a variable value which depends on the type of application or user's setting. For example, if there is a need to minutely move a cursor in a sentence having a small font size, an object speed is set to be smaller than a drag speed. If there is a need to scroll many items to find a desired one, an object speed is set to be greater than a drag speed.

Then, based on the ratio defined in step S270 or S280, the control unit 160 controls the object to be moved and displayed in response to a drag input at step S290.

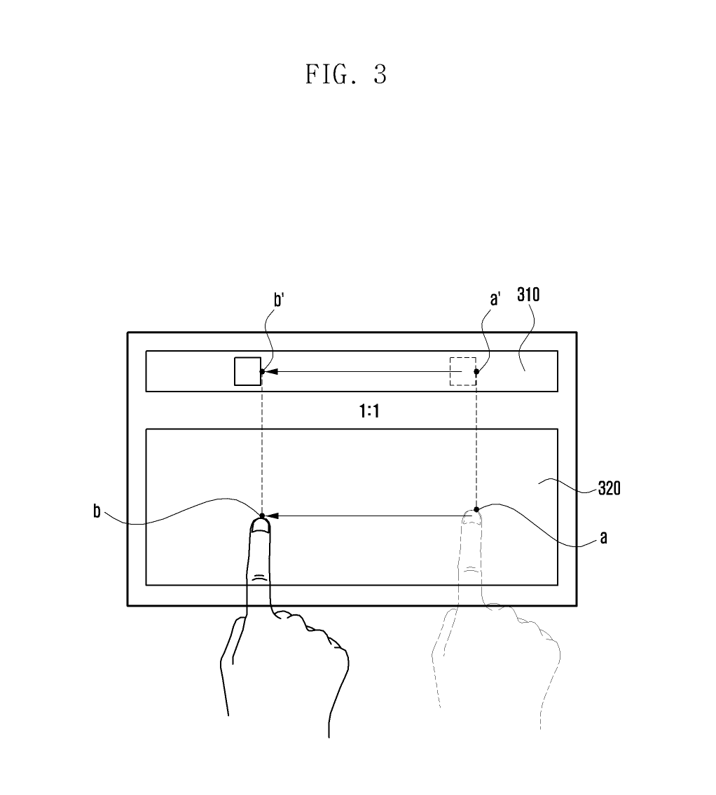

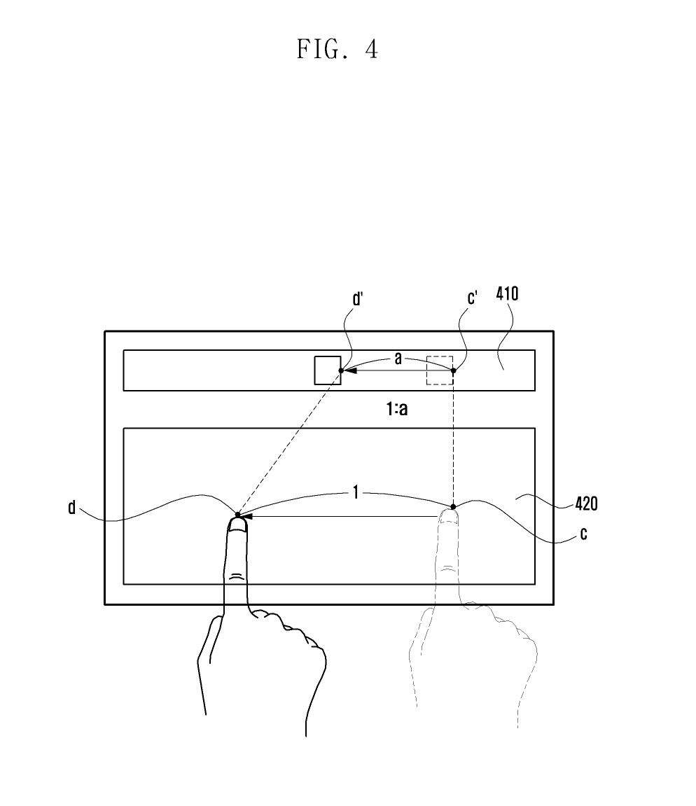

FIGS. 3 and 4 are schematic diagrams illustrating a process of moving an object based on the ratio of a drag speed to an object speed in accordance with embodiments of the invention.

FIG. 3 is a schematic diagram illustrating a process of moving an object in response to a drag input when a drag speed and an object speed are set equally.

As shown in FIG. 3, the display unit 142 of the mobile terminal 100 displays an object 310 and a control region 320. As mentioned above, the control region 320 is an area where a touch input and/or a drag input are received to control the object 310. Although FIG. 3 illustrates the object 310 located at the outside of the control region 320, in an alternate embodiment, the object 310 may be located at the inside of the control region 320.

The control unit 160 detects user's touch input from the control region 320. If a drag input is completed and detected within a predetermined time, e.g., 0.5 second, after a detection of the initial touch input, the control unit 160 defines the ratio of a drag speed to an object speed as an equal value. In other words, the drag speed and the object speed are set equally. Note that the predetermined time adjustable (i.e., by a user).

Thus, if a drag input is inputted from the position “a” to the position “b” in the control region 320 within the predetermined time, the control unit 160 moves the object from the position “a” to the position “b” at the same speed as the drag speed.

Meanwhile, FIG. 4 is a diagram illustrating a process of moving an object in response to a drag input when a drag speed and an object movement speed are set differently.

As shown in FIG. 4, the display unit 142 of the mobile terminal 100 displays an object 410 and a control region 420.

The control unit 160 detects user's touch input from the control region 420. If a drag input is detected after a predetermined time, e.g., 0.5 second, has elapsed, the control unit 160 defines the ratio of a drag speed to an object movement speed as an unequal value, 1 to a, in which “a” is greater or smaller than 1. In other words, the drag speed and the object speed are set differently. Note that if the drag motion is detected after the 0.5 second, the drag speed and the object speed are set differently. For example, if the drag input is 0.5 second, the “a” can be 0.9. Also, if the drag input is 0.6 sec, the “a” cab be 0.8, and so on.

Thereafter, if a drag input is inputted from the position “c” to the position “d” in the control region 420, the control unit 160 moves the object from the position “c” to the position “d” at a speed of “a” in comparison with the drag speed.

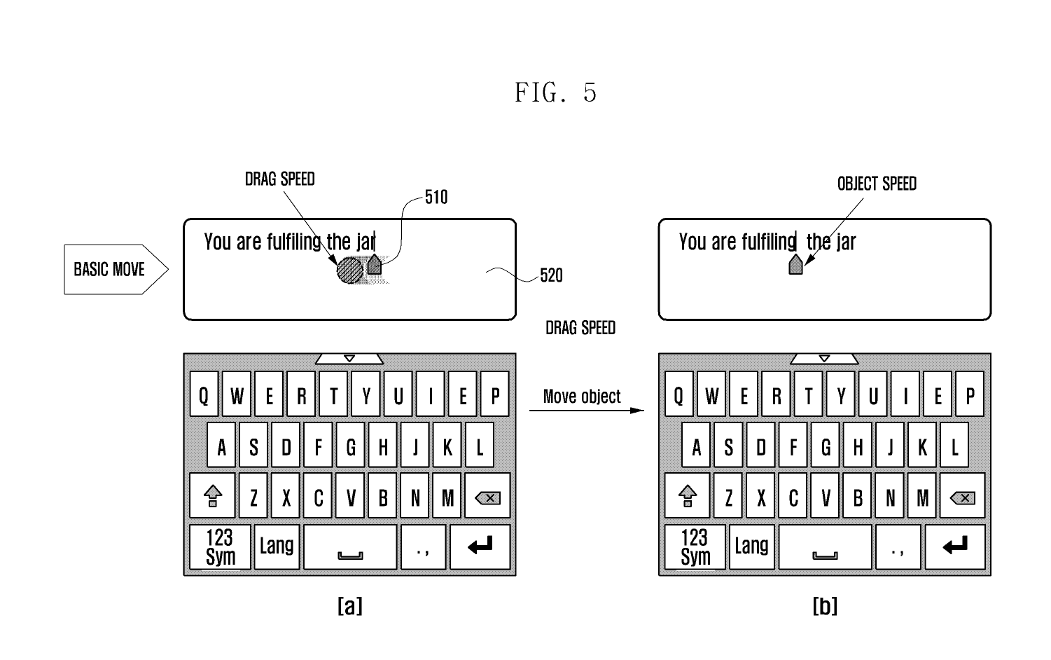

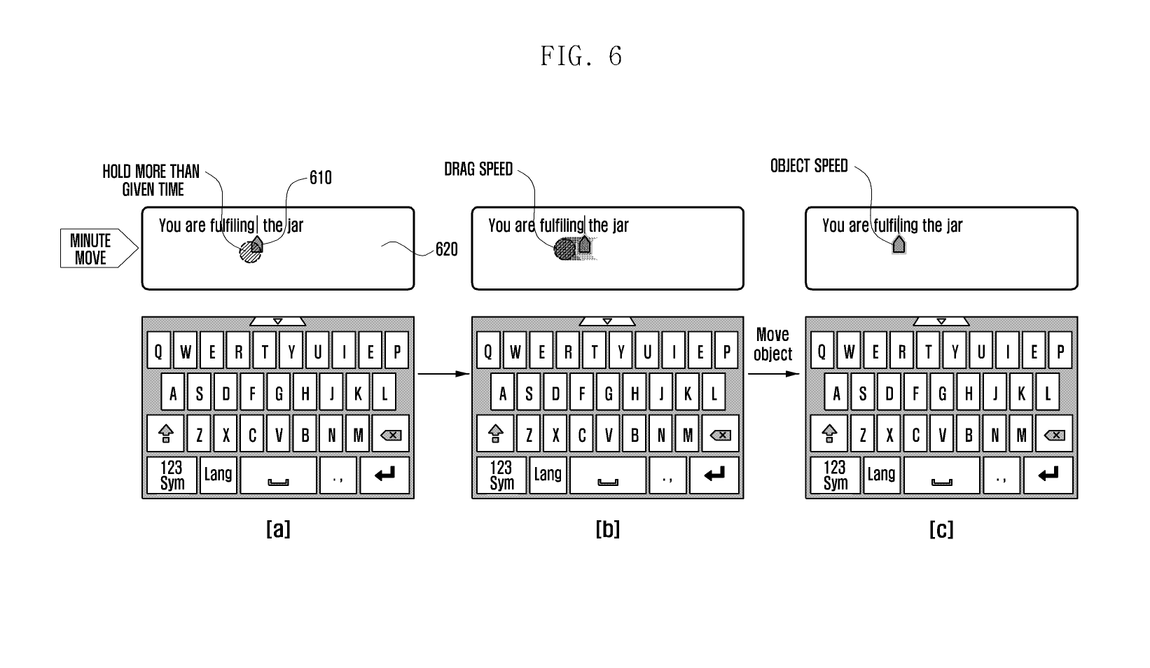

FIGS. 5 and 6 are schematic diagrams illustrating a process of moving a cursor based on the ratio of a drag speed to a cursor speed in accordance with embodiments of the invention.

FIG. 5 is a schematic diagram illustrating a process of moving a cursor if a drag speeds and a cursor speed are set equally.

In (a) and (b) of FIG. 5, a cursor 510 indicating a position for a letter input and a control region 520 for receiving a touch input and/or a drag input for controlling the movement of the cursor are shown.

As shown in (a) of FIG. 5, the control unit 160 detects a drag input of moving a touch input to the left after the touch input is received in the control region 520. Then, as shown in (b) of FIG. 5, the control unit 160 controls the cursor 510 to move to the left at the same speed as the drag speed.

FIG. 6 is a schematic diagram illustrating a process of moving a cursor if a drag speeds and a cursor speed are set differently.

In (a) and (b) of FIG. 6, a cursor 610 indicating a position for a letter input and a control region 620 for receiving a touch input and/or a drag input for controlling the movement of the cursor are shown.

As shown in (a) of FIG. 6, the control unit 160 detects an elapse of a predetermined time (i.e., 0.5 seconds) after a touch input is received and completed in the control region 620. Then, the control unit 160 defines the ratio of a drag speed to a cursor speed as an unequal value. In this case, it is supposed that a drag speed is set to be smaller than a cursor speed.

Additionally, as shown in (b) of FIG. 6, the control unit 160 detects a drag input of moving a touch input to the left. Then, as shown in (c) of FIG. 6, the control unit 160 controls the cursor 610 to move to the left at the speed reduced with the defined ratio in comparison with the drag speed.

In this embodiment, the cursor may be moved leftward space by space in a sentence. Namely, when a leftward drag input is detected at a certain speed, the control unit 160 may control the cursor to move leftward one by one in the minimum unit (for example, a character) at a speed under the drag speed.

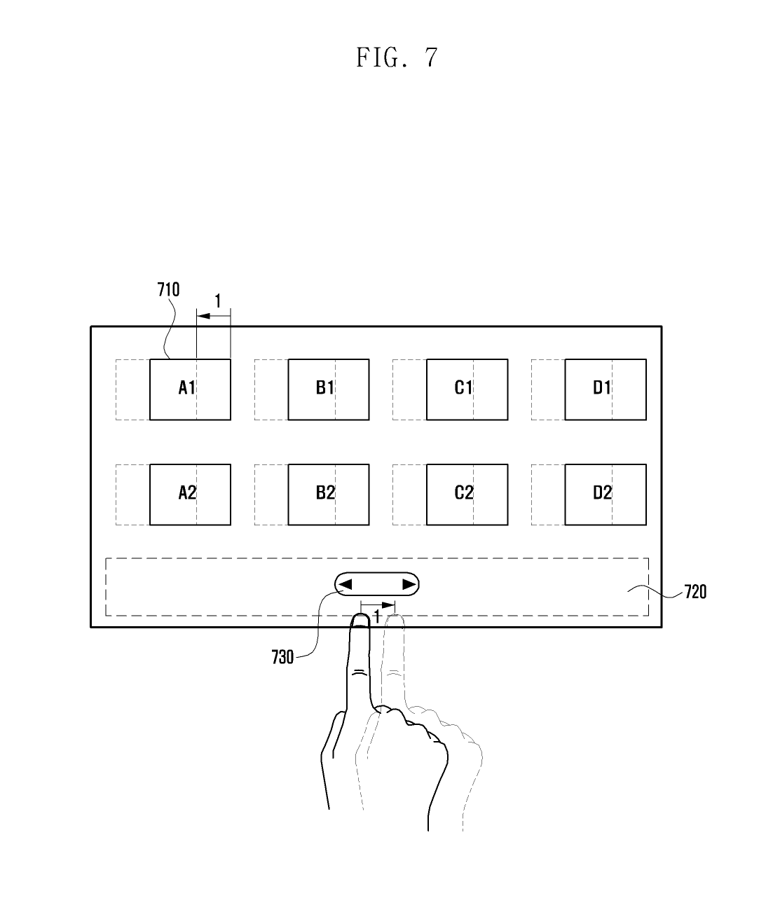

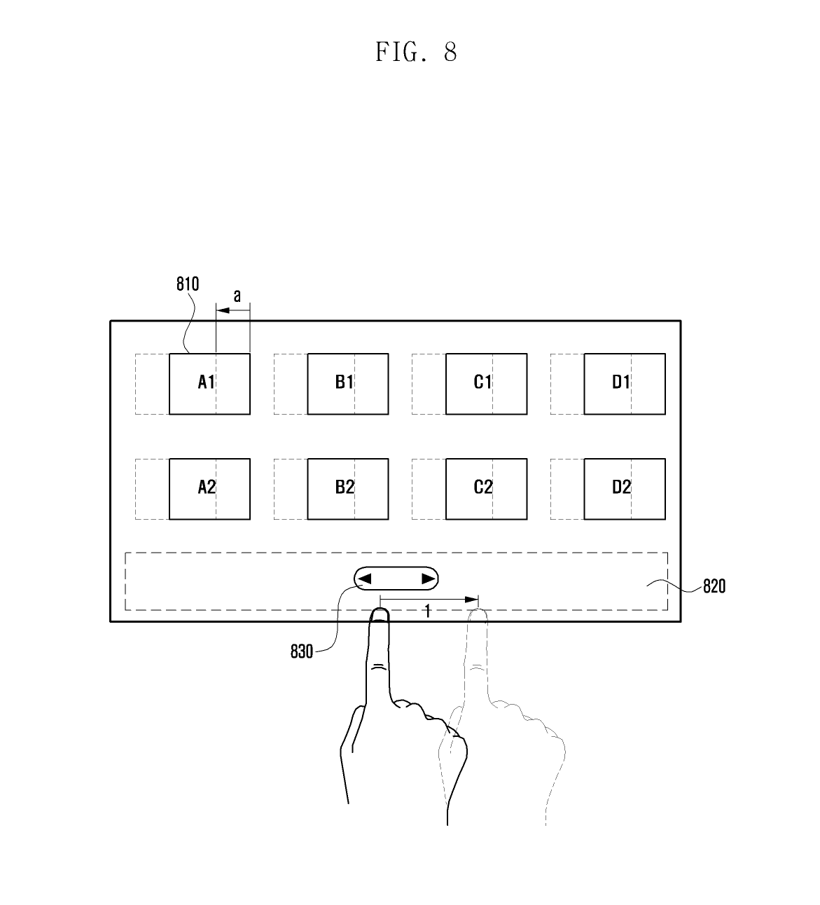

FIGS. 7 and 8 are schematic diagrams illustrating a process of moving image items in a gallery application based on the ratio of a drag speed to an image movement speed in accordance with embodiments of the invention.

FIG. 7 is a schematic diagram illustrating a process of moving the image items if a drag speeds and an item speed are set equally. In this embodiment, moving the image items not only scrolls the screen containing the image items, but also changes the current screen to another screen in order to display other image items which are not contained in the current screen.

In FIG. 7, an object which is the target of control is a plurality of image items 710 which are arranged in the display unit 142 according to a predefined rule. For example, the plurality of image items may be arranged in a grid pattern. In this case, the image items 710 are arranged in a grid or matrix form. Additionally, a control region 720 which receives a touch input and/or a drag input in order to control the movement of the image items is displayed. Also, a handler 730 which is located in the control region 720 is displayed as the target of the touch and/or drag input. In another embodiment, the handler 730 may be not used, namely, removed from the screen.

After a touch input is detected through the handler 730, the control unit 160 detects a drag input of moving rightward the touch input. Then, the control unit 160 controls the image items arranged in a grid or matrix form to move to the left at the same speed as the drag speed. As the image items are moved leftward, hidden image items arranged at the right of the image items D1 and D2 are moved to and displayed on the display unit 142.

Although in this embodiment the image items are moved in the opposite direction to a drag direction, an alternative embodiment in which the image items are moved in the same direction as a drag direction is also possible.

FIG. 8 is a schematic diagram illustrating a process of moving the image items if a drag speeds and an image movement speed are set differently. In this embodiment, moving the image items includes scrolls and changing the screen containing the image items.

In FIG. 8, an object which is the target of control is a plurality of image items 810 which are arranged in the display unit 142 according to a predefined rule. For example, the plurality of image items may be arranged in a grid pattern. In this case, the image items 810 are arranged in a grid or matrix form. Additionally, a control region 820 which receives a touch input and/or a drag input in order to control the movement of the image items is displayed. Also, a handler 830 which is located in the control region 820 is displayed as the target of the touch and/or drag input. In another embodiment, the handler 830 may be not used, namely, removed from the screen.

After a touch input is received through the handler 830, the control unit 160 detects the drag motion after an elapse of a predetermined time (i.e., 0.5 seconds). Then, the control unit 160 defines the ratio of a drag speed to an image movement speed as an unequal value. In this case, a drag speed is set to be smaller than an image movement speed.

Thereafter, the control unit 160 detects from the handler 830 a drag input of moving rightward the touch input. Then, the control unit 160 controls the image items arranged in a grid or matrix form to move to the left at an increasing speed in comparison with the drag speed. As the image items are moved leftward, hidden image items arranged at the right of the image items D1 and D2 are moved to and displayed on the display unit 142.

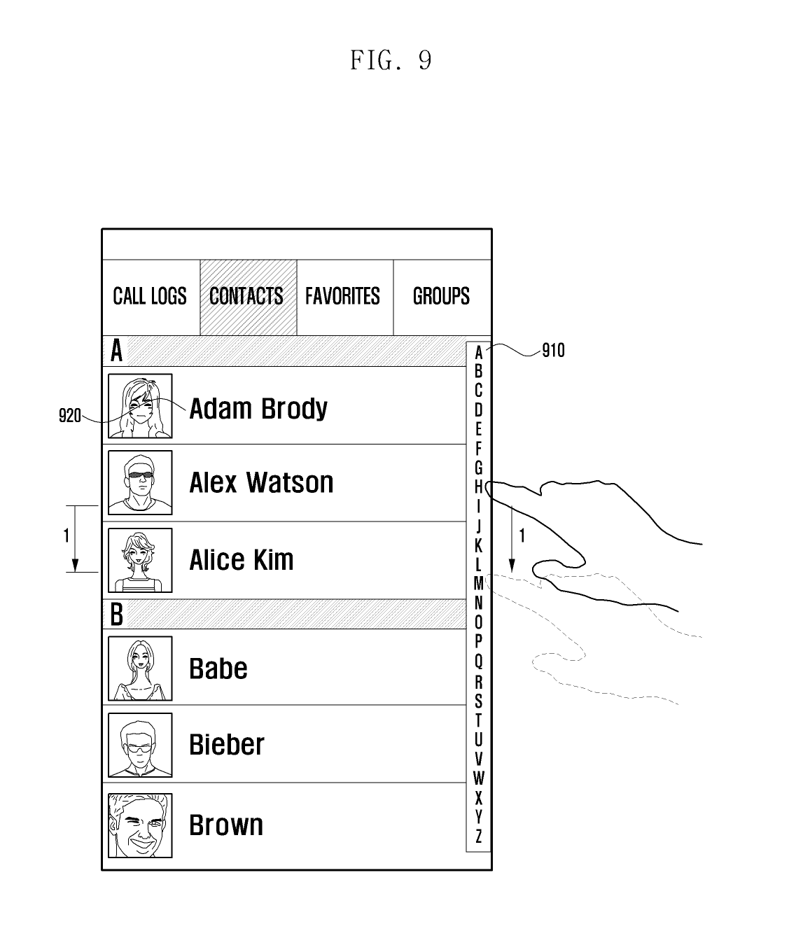

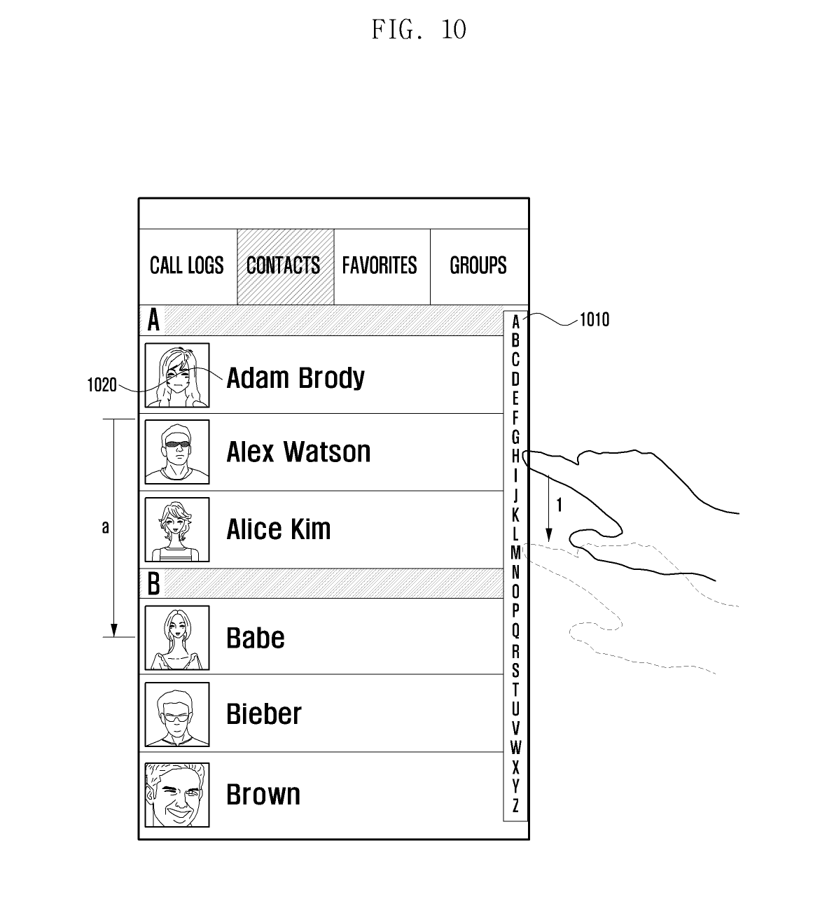

FIGS. 9 and 10 are schematic diagrams illustrating a process of moving list items in a list of contacts based on the ratio of a drag speed to a list speed in accordance with embodiments of the invention.

FIG. 9 is a schematic diagram illustrating a process of moving the list items if a drag speeds and a list speed are set equally. In this embodiment, moving the list items not only scrolls the screen containing the list items, but also changes the current screen to another screen in order to display other list items which are not contained in the current screen.

In FIG. 9, an object which is the target of control is a plurality of list items 910, e.g., contacts, which are arranged in the display unit 142 according to a predefined rule, for example, as described in FIG. 9, from up to down of screen. In this case, the list items 910 are arranged lengthwise in alphabetical order. Additionally, a control region 910 which receives a touch input and/or a drag input in order to control the movement of the list items is displayed.

After a touch input is detected through the control region 910, the control unit 160 detects a drag input of moving the touch input downward. Then, the control unit 160 controls the list items arranged lengthwise to move downward at the same speed as the drag speed.

Although in this embodiment the list items are moved in the same direction to a drag direction, an alternative embodiment in which the list items are moved in the opposite direction as a drag direction is also possible.

FIG. 10 is a schematic diagram illustrating a process of moving the list items if a drag speeds and an image movement speed are set differently.

In FIG. 10, an object which is the target of control is a plurality of list items 1020, e.g., contacts, which are arranged in the display unit according to a predefined rule, for example, as described in FIG. 10, from up to down of screen. In this case, the list items 1020 are arranged lengthwise in alphabetical order. Additionally, a control region 1010 which receives a touch input and/or a drag input in order to control the movement of the list items is displayed.

After a touch input is received in the control region 1010, the control unit 160 detects the drag motion after an elapse of a predetermined time (i.e., 0.5 second). Then, the control unit 160 defines the ratio of a drag speed to a list speed as an unequal value. In this case, it is supposed that a drag speed is set to be smaller than a list speed.

According to the teachings of the present invention, the ratio of a drag speed to an object speed is set differently or defined as a certain unequal value.

Thereafter, the control unit 160 detects from the control region 1010 a drag input of moving the touch input downward. Then the control unit 160 controls the list items arranged lengthwise to move downward at an increasing speed in comparison with the drag speed.

Although in this embodiment the list items are moved in the same direction to a drag direction, an alternative embodiment in which the list items are moved in the opposite direction as a drag direction is also possible.

As discussed hereinbefore, when a drag input is detected after a predetermined time has elapsed from the time point of a touch input, the ratio of a drag speed to an object speed is set differently so that an object displayed in the screen is moved according to the set ratio in response to a drag input. Using this feature, it is therefore possible to move a cursor minutely in a sentence having a small font size and a narrow spacing or to scroll image items or list items quickly. It should be also noted that although 0.5 second is used to represent the predetermined time for illustrative purposes, other time periods can be used as a threshold time to set the ratio of a drag speed to an object speed according to the teachings of the present invention.

The above-described methods according to the present invention can be implemented in hardware, firmware or via execution of software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the invention have been described in detail hereinabove, it should be understood that many variations and modifications of the basic inventive concept herein described, which may be apparent to those skilled in the art, will still fall within the spirit and scope of the exemplary embodiments as defined in the appended claims.

What is claimed is:

1. A method for controlling a speed of an object moving in a touch screen, the method comprising:
displaying a control region for controlling a movement of the object;
in response to detecting an initial touch input from the control region, determining whether duration of a drag input after the initial touch input occurs longer than a predetermined time period;
defining a ratio of a drag speed to an object speed based on the determination outcome; and
moving the object in response to the drag input according to the defined ratio.

2. The method of claim 1, wherein defining the ratio further comprises setting the drag speed and the object speed differently by a predefined amount when the duration of the drag input after the initial touch input is longer than the predetermined time period.

3. The method of claim 1, wherein defining the ratio further comprises setting the drag speed and the object speed equally when the duration of the drag input after the initial touch input is less than the predetermined time period.

4. The method of claim 1, wherein the object is provided at an inside or outside of the control region.

5. The method of claim 1, wherein the control region comprises a handler for receiving the touch input and the drag input.

6. The method of claim 1, wherein the object comprises at least one of a cursor, an image item, and a list item.

7. The method of claim 6, wherein moving the object comprises, if the object is the cursor, moving the cursor space by space in a minimum unit in response to the drag input.

8. A mobile terminal comprising:
a touch screen configured to display an object and a control region; and
a control unit configured to, when an initial touch input is detected from the control region, determine whether a drag input after the initial touch input occurs longer than a predetermined time period, define a ratio of a drag speed to an object speed based on the determination outcome, and move the object in response to the drag input according to the defined ratio.

9. The mobile terminal of claim 8, wherein the control unit is further configured to set the drag speed and the object speed differently when the drag input is detected after the predetermined time period has elapsed from the initial touch input.

10. The mobile terminal of claim 8, wherein the control unit is further configured to, set the drag speed and the object speed equally when the drag input is completed before the predetermined time period has elapsed from the initial touch input.

11. The mobile terminal of claim 8, wherein the object is located at an inside or outside of the control region.

12. The mobile terminal of claim 8, wherein the control region further comprises a handler for receiving the touch input and the drag input.

13. The mobile terminal of claim 8, wherein the object further comprises at least one of a cursor, an image item, and a list item.

14. The mobile terminal of claim 13, wherein the control unit is further configured to, if the object is the cursor, move the cursor space by space in the minimum unit in response to the drag input.
